(19) United States
(12) Patent Application Publication
(10) Pub. No.: US 2026/0175652 A1
(43) Pub. Date: Jun. 25, 2026

(54) VEHICLE WINDOW SCREENING DEVICE

(71) Applicants: Victor Williams, Austin, TX (US); Brenda Williams, Austin, TX (US)

(72) Inventors: Victor Williams, Austin, TX (US); Brenda Williams, Austin, TX (US)

(21) Appl. No.: 18/989,807

(22) Filed: Dec. 20, 2024

(51) Int. Cl. B60J 1/20

(52) U.S. Cl. CPC B60J 1/20

(57) ABSTRACT

A vehicle window screening device for excluding insects from an interior space of a vehicle includes a mesh panel, which has a perimeter and an inner face. The mesh panel is shaped to be complementary to but larger than a window opening of a vehicle so that the perimeter is larger than a circumference of the window opening. The perimeter thus is spaced from the circumference upon positioning of the mesh panel over the window opening. Cups attached to the inner face adjacent to the perimeter are resiliently compressible and can be compressed against the vehicle to attach the mesh panel to the vehicle, thereby covering the window opening to exclude insects from the interior space of the vehicle. A slit is positioned in the mesh panel and allows a user to reach through the mesh panel. A closure attached to the mesh panel along the slit reversibly closes the slit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to screening devices and more particularly pertains to a new screening device for excluding insects from an interior space of a vehicle. A driver of a vehicle may sometimes wish to sit in their vehicle with a window opened or partially opened so as to ventilate the interior space of the vehicle. This may allow flying insects, such as mosquitoes, flies, bees, wasps, and the like, to enter the interior space of the vehicle. A screening device to exclude these insects from the interior space of the vehicle while allowing the driver to reach through the screening device using a closable slit would be desirable.

### (2) Description of Related Art Including Information Disclosed Under 37 CFR 1.97 and 1.98

The prior art relates to screening devices, which may comprise a pair of matched magnetic strips or a hook and loop fastener, with one element being mounted to a vehicle window frame and the other element to a screen, to removably attach the screen over a window opening. The prior art also may comprise a screen with magnetic strips or magnets around its perimeter which magnetically attaches directly to a vehicle. The prior art also may comprise screens that are rigid and/or which have rigid frames. The prior art does not teach a flexible screen through which a user can reach using a selectively closable slit.

### BRIEF SUMMARY OF THE INVENTION

An embodiment of the disclosure meets the needs presented above by generally comprising a mesh panel, which has a shape, a perimeter, an inner face, and an outer face. The shape of the mesh panel is configured to be complementary to a window opening of a vehicle. The mesh panel is configured to be larger than the window opening so that the perimeter of the mesh panel is larger than a circumference of the window opening. The perimeter thus is spaced from the circumference upon positioning of the mesh panel over the window opening. A plurality of cups is attached to the inner face of the mesh panel adjacent to the perimeter of the mesh panel. The cups comprises elastomer so that the cups are resiliently compressible. The cups are configured to be compressed against the vehicle to attach the mesh panel to the vehicle proximate to the circumference of the window opening, thereby covering the window opening and configuring the mesh panel to exclude insects from an interior space of the vehicle. A slit is positioned in the mesh panel and is configured to allow a user to reach through the mesh panel. A closure is attached to the mesh panel and extends along the slit so that the closure is positioned to reversibly close the slit.

Another embodiment of the disclosure includes a vehicle window screening system, which comprises a vehicle and a vehicle window screening device, as per the disclosure above. The vehicle has an interior space and a window opening, which has a circumference. The mesh panel of the vehicle window screening device is attached to the vehicle by the plurality of cups of the vehicle window screening device. The mesh panel is positioned over the window opening to exclude insects from the interior space of the vehicle. The slit in the mesh panel is configured to allow a user to reach through the mesh panel to retrieve or receive an article. The closure of the vehicle window screening device is attached to the mesh panel and extends along the slit so that the closure is positioned to reversibly close the slit.

Yet another embodiment of the disclosure includes a method for excluding insects from an interior space of a vehicle. The method entails provision of a vehicle window screening device, according to the disclosure above. Steps of the method include positioning of the mesh panel over the window opening, compressing the cups against the vehicle proximate to the circumference of the window opening to attach the mesh panel to the vehicle, opening a window of the vehicle covering the window opening thereby allowing air to pass through the mesh panel while the insects are excluded from the interior space of the vehicle, manipulating the closure to open the slit, receiving or retrieving an article that is external to the vehicle, and manipulating the closure to close the slit

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a vehicle window screening device according to an embodiment of the disclosure.

FIG. 2 is an inner view of an embodiment of the disclosure.

FIG. 3 is an outer view of an embodiment of the disclosure.

FIG. 4 is an in-use view of an embodiment of the disclosure.

FIG. 5 is a flow diagram for a method utilizing an embodiment of the disclosure.

### DETAILED DESCRIPTION OF THE INVENTION

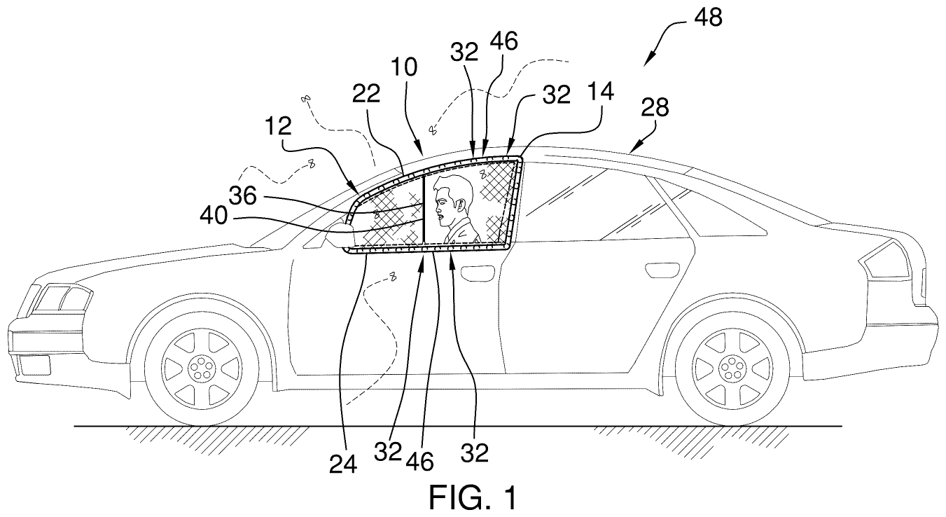

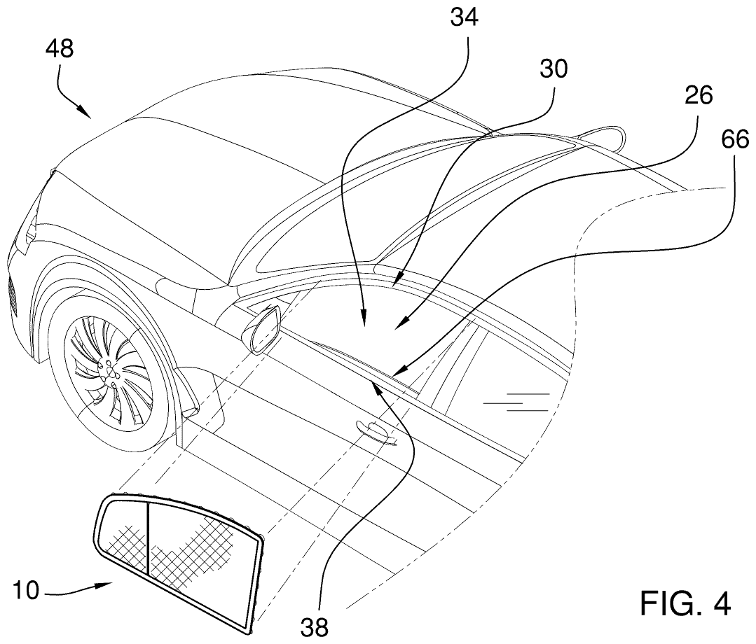

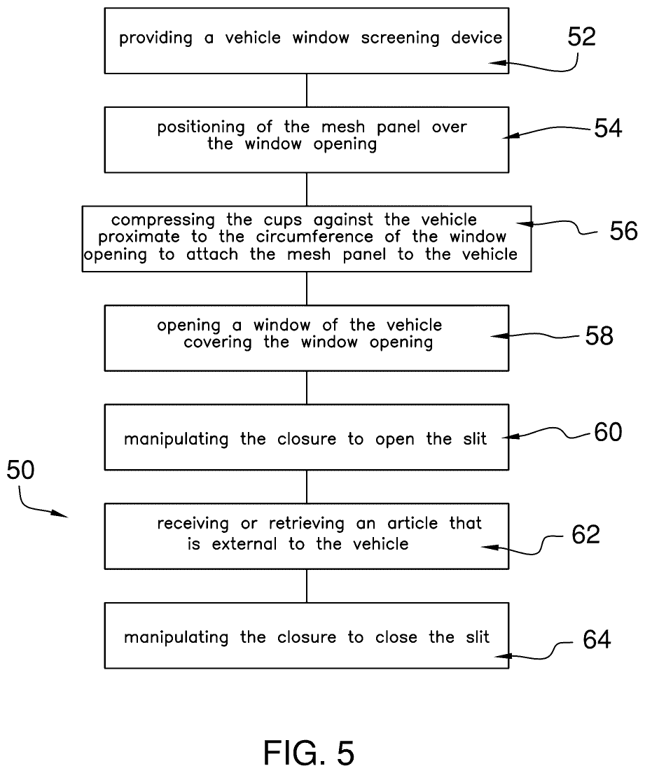

With reference now to the drawings, and in particular to FIGS. 1 through 5 thereof, a new screening device embodying the principles and concepts of an embodiment of the disclosure and generally designated by the reference numeral 10 will be described.

As best illustrated in FIGS. 1 through 5, the vehicle window screening device 10 generally comprises a mesh panel 12, which has a shape 14, a perimeter 16, an inner face 18, an outer face 20, an upper limit 22, and a lower limit 24. The mesh panel 12 comprises plastic wire, metal wire, fiberglass, or the like and thus is flexible and configured to be rolled for stowage. The shape 14 of the mesh panel 12 is configured to be complementary to a window opening 26 of a vehicle 28. The mesh panel 12 is configured to be larger than the window opening 26 so that the perimeter 16 of the mesh panel 12 is larger than a circumference 30 of the window opening 26. The perimeter 16 thus is spaced from the circumference 30 upon positioning of the mesh panel 12 over the window opening 26. As will be apparent, window openings 26 of vehicles 28 consist of a wide variety of sizes and shapes, thus the mesh panel 12 also would be manufactured in a wide variety of sizes and shapes 14.

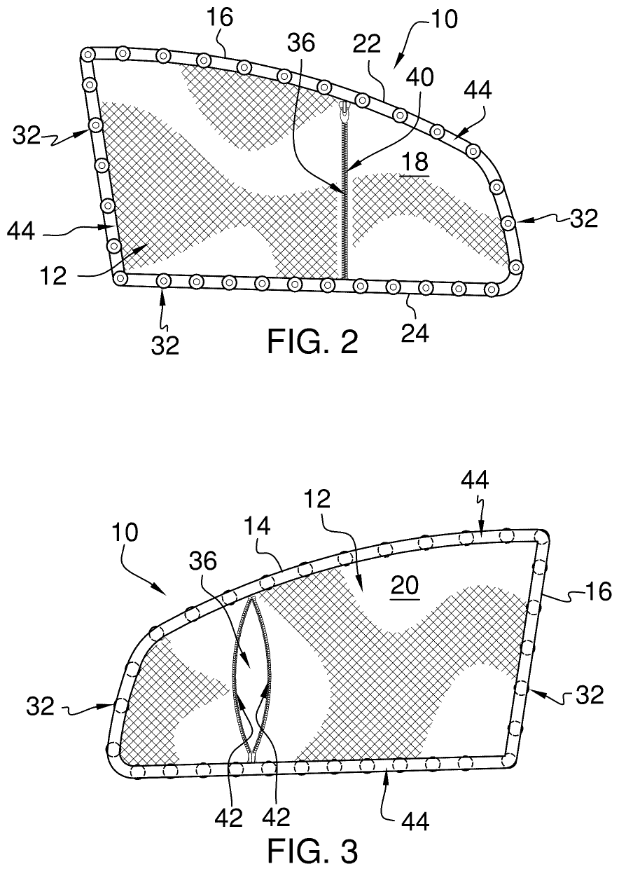

A plurality of cups 32 is attached to the inner face 18 of the mesh panel 12 adjacent to the perimeter 16 of the mesh panel 12, as is shown in FIG. 2. The cups 32 comprises elastomer, such as silicone, rubber, or the like, so that the cups 32 are resiliently compressible. The cups 32 are configured to be compressed against the vehicle 28 to attach the mesh panel 12 to the vehicle 28 proximate to the circumference 30 of the window opening 26. The mesh panel 12 thus is configured to cover the window opening 26 to exclude insects from an interior space 34 of the vehicle 28. It also is anticipated that magnets or hook and loop fasteners be used in place of the plurality of cups 32 to effect attachment of the mesh panel 12 to the vehicle 28.

A slit 36 is positioned in the mesh panel 12 and is configured to allow a user to reach through the mesh panel 12 to retrieve or to receive an article that is external to the vehicle 28. The slit 36 may extend from proximate to the upper limit 22 to proximate to the lower limit 24 of the mesh panel 12, as is shown in the figures, or may be alternatively positioned, such as substantially parallel to a bottom edge 38 of the window opening 26. The slit 36 as shown is linear but the present invention also anticipates the slit 36 being curved. A closure 40 is attached to the mesh panel 12 and extends along the slit 36 so that the closure 40 is positioned to reversibly close the slit 36. The closure 40 may comprise a zipper 42, as is shown in the figures, paired magnetic strips, a hook and loop fastener, or the like.

A strip 44 is attached to the inner face 18 of the mesh panel 12 and extends around the perimeter 16 of the mesh panel 12. The cups 32 of protrude through the strip 44 and are available for attachment of the mesh panel 12 to the vehicle 28. The strip 44 is configured to prevent contact of the mesh panel 12 with the vehicle 28 and to fill or partially fill gaps 46 between the mesh panel 12 and the vehicle 28. The strip 44 thus deters the insects from entering the interior space 34 of the vehicle 28 by crawling between the mesh panel 12 along its perimeter 16 and the vehicle 28 along the circumference 30 of the window opening 26. The strip 44 typically will comprise elastomer, cloth, or the like, and also may extend around the perimeter 16 of the mesh panel 12 and be attached to the outer face 20 of the mesh panel 12. Thus configured, the strip 44 provides a comfortable surface upon which to press to attach the cups 32 to the vehicle 28 and prevents scratching of the vehicle 28 by the mesh panel 12.

The present invention also anticipates a vehicle window screening system 48, which comprises a vehicle 28 and a vehicle window screening device 10, as per the specification above and as is shown in FIG. 1. The vehicle 28 has an interior space 34 and a window opening 26, which has a circumference 30. The mesh panel 12 of the vehicle window screening device 10 is attached to the vehicle 28 by the plurality of cups 32 of the vehicle window screening device 10. The mesh panel 12 is positioned over the window opening 26 to exclude insects from the interior space 34 of the vehicle. The slit 36 in the mesh panel 12 is configured to allow a user to reach through the mesh panel 12 to retrieve or receive an article. The closure 40 of the vehicle window screening device 10 is attached to the mesh panel 12 and extends along the slit 36 so that the closure 40 is positioned to reversibly close the slit 36.

In use, the vehicle window screening device 10 enables a method for excluding insects from an interior space of a vehicle 50. The method 50 comprises a first step 52 of providing a vehicle window screening device 10, according to the specification above. A second step 54 of the method 50 is positioning of the mesh panel 12 over the window opening 26. A third step 56 of the method 50 is compressing the cups 32 against the vehicle 28 proximate to the circumference 30 of the window opening 26 to attach the mesh panel 12 to the vehicle 28. A fourth step 58 of the method 50 is opening a window 66 of the vehicle 28 covering the window opening 26 thereby allowing air to pass through the mesh panel 12 while the insects are excluded from the interior space 34 of the vehicle 28. A fifth step 60 of the method 50 is manipulating the closure 40 to open the slit 36. A sixth step 62 of the method 50 is receiving or retrieving an article that is external to the vehicle 28. A seventh step 64 of the method 50 is manipulating the closure 40 to close the slit 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle window screening device comprising:
a mesh panel having a shape, a perimeter, an inner face, and an outer face, the shape of the mesh panel being configured to be complementary to a window opening of a vehicle, the mesh panel being configured to be larger than the window opening such that the perimeter of the mesh panel is larger than a circumference of the window opening and spaced from the circumference upon positioning of the mesh panel over the window opening;
a plurality of cups being attached to the inner face of the mesh panel adjacent to the perimeter of the mesh panel, the cups comprising elastomer such that the cups are resiliently compressible, wherein the cups are configured for compressing against the vehicle for attaching the mesh panel to the vehicle proximate to the circumference of the window opening for covering the window opening, whereby the mesh panel is configured for excluding insects from an interior space of the vehicle;
a slit being positioned in the mesh panel, wherein the slit is configured for allowing a user to reach through the mesh panel; and
a closure being attached to the mesh panel and extending along the slit such that the closure is positioned for reversibly closing the slit.

2. The vehicle window screening device of claim 1, wherein the mesh panel is flexible, wherein the mesh panel is configured for being rolled for stowage.

3. The vehicle window screening device of claim 2, wherein the mesh panel comprises plastic wire, metal wire, or fiberglass.

4. The vehicle window screening device of claim 1, further comprising a strip, the strip being attached to the inner face of the mesh panel and extending around the perimeter of the mesh panel, the cups of the plurality of cups protruding through the strip, wherein the strip is configured for preventing contact of the mesh panel with the vehicle and for filling or partially filling gaps between the mesh panel and the vehicle.

5. The vehicle window screening device of claim 4, further comprising the strip extending around the perimeter of the mesh panel and being attached to the outer face of the mesh panel.

6. The vehicle window screening device of claim 4, wherein the strip comprises elastomer or cloth.

7. The vehicle window screening device of claim 1, wherein the cups comprise silicone or rubber.

8. The vehicle window screening device of claim 1, wherein the closure comprises a zipper.

9. The vehicle window screening device of claim 1, wherein:
the mesh panel has an upper limit and a lower limit; and
the slit extends from proximate to the upper limit to proximate to the lower limit.

10. The vehicle window screening device of claim 1, further comprising:
the mesh panel being flexible, wherein the mesh panel is configured for being rolled for stowage, the mesh panel comprising plastic wire, metal wire, or fiberglass, the mesh panel has an upper limit and a lower limit;
a strip being attached to the inner face of the mesh panel and extending around the perimeter of the mesh panel, the strip extending around the perimeter of the mesh panel and being attached to the outer face of the mesh panel, the strip comprising elastomer or cloth, the cups of the plurality of cups protruding through the strip, wherein the strip is configured for preventing contact of the mesh panel with the vehicle and for filling or partially filling gaps between the mesh panel and the vehicle;
the cups comprising silicone or rubber;
the closure comprising a zipper; and
the slit extends from proximate to the upper limit to proximate to the lower limit of the mesh panel.

11. A vehicle window screening system comprising:
a vehicle having a window opening and an interior space, the window opening having a circumference;
a mesh panel having a shape, a perimeter, an inner face, and an outer face, the shape of the mesh panel being complementary to the window opening, the mesh panel being larger than the window opening such that the perimeter of the mesh panel is larger than the circumference of the window opening and spaced from the circumference upon positioning of the mesh panel over the window opening;
a plurality of cups being attached to the inner face of the mesh panel adjacent to the perimeter of the mesh panel, the cups comprising elastomer such that the cups are resiliently compressible, the cups being compressed against the vehicle proximate to the circumference of the window opening such that the mesh panel is attached to the vehicle and covers the window opening for excluding insects from the interior space of the vehicle;
a slit being positioned in the mesh panel, wherein the slit is configured for allowing a user to reach through the mesh panel; and
a closure being attached to the mesh panel and extending along the slit such that the closure is positioned for reversibly closing the slit.

12. A method for excluding insects from a method for excluding insects from an interior of a vehicle, the method comprising the steps of:
providing a vehicle window screening device comprising:
a mesh panel having a shape, a perimeter, an inner face, and an outer face, the shape of the mesh panel being configured to be complementary to a window opening of the vehicle, the mesh panel being configured to be larger than the window opening such that the perimeter of the mesh panel is larger than a circumference of the window opening and spaced from the circumference upon positioning of the mesh panel over the window opening;
a plurality of cups being attached to the inner face of the mesh panel adjacent to the perimeter of the mesh panel, the cups comprising elastomer such that the cups are resiliently compressible, wherein the cups are configured for compressing against the vehicle proximate to the circumference of the window opening for attaching the mesh panel to the vehicle for covering the window opening, whereby the mesh panel is configured for excluding insects from the interior space of the vehicle;
a slit being positioned in the mesh panel, wherein the slit is configured for allowing a user to reach through the mesh panel; and
a closure being attached to the mesh panel and extending along the slit such that the closure is positioned for reversibly closing the slit;
positioning of the mesh panel over the window opening;
compressing the cups against the vehicle proximate to the circumference of the window opening to attach the mesh panel to the vehicle;
opening a window of the vehicle covering the window opening thereby allowing air to pass through the mesh panel while the insects are excluded from the interior space of the vehicle;
manipulating the closure to open the slit;
receiving or retrieving an article that is external to the vehicle; and
is manipulating the closure to close the slit.
